(19) United States
(12) Patent Application Publication
(10) Pub. No.: US 2006/0133445 A1
(43) Pub. Date: Jun. 22, 2006

(54) Flammability tester

(75) Inventor: Richard E. Lyon, Absecon, NJ (US)

Correspondence Address: James J. Drew;Federal Aviation Administration Technical Center, Atlantic City International Airport, Pomona, NJ, 08405, US

(73) Assignee: U.S. Department of Transportation

(21) Appl. No.: 11/012,215

(22) Filed: Dec. 16, 2004

(51) Int. Cl. G01N 25/00

(52) U.S. Cl. 374/8

(57) ABSTRACT

A flammability tester for samples in the milligram range. A tube with a lower pyrolyzing region, or pyrolyzer, contains a sample that is heated to thermally degrade in the absence of oxygen, or pyrolyzed, to produce fuel gases. An inert gas carries the fuel gases to an upper combustion region, or combustor, where oxygen is measured into the gas flow containing the inert gas and fuel gases. Combustion of the fuel gases occurs at a temperature where the reaction time for almost all of the fuel gases is at or below 10 seconds. Under these conditions, the combustor volume need for complete combustion is small, permitting the fuel gases to be oxidized as they are liberated and travel from the pyrolyzer into the combustor in what is essentially sequential flow. Complete combustion in such a small volume produces a large decrease in the oxygen content of the gases emerging from the combustor, allowing the use of a simple inexpensive oxygen analyzer to measure the oxygen content of the gases emerging from the combustor. Oxygen depletion can be used to determine flammability parameters of the sample. The tester can be fitted with a thermometer to measure the combustion temperature of the pyrolyzed sample. The tester may also be configured to use a carbon dioxide analyzer to measure additional flammability parameters. The tester may also be combined with a separate thermogravimetric analyzer to yield further flammability parameters where the mass loss rate of the pyrolyzing sample is needed.

### STATEMENT OF GOVERNMENT INTEREST

The present invention may be made or used by or for the Government of the United States without the payment of any royalties thereon.

### FIELD OF THE INVENTION

The present invention relates generally to calorimeters, and more specifically to calorimeters used to measure multiple flammability parameters of combustible materials, including ignition temperature, burning rate, heat release rate, and heat of combustion, using small samples. A flammability tester that simultaneously measures multiple flammability parameters is derived from such calorimeters and is useful for quickly and accurately testing milligram and larger samples of combustible materials.

### BACKGROUND

In a fire, the temperature at which a combustible material ignites (the ignition temperature), the rate of mass loss as the material subsequently burns (the burning rate), the rate at which the material releases heat in flaming combustion (heat release rate), and the maximum amount of heat that can be released by burning (heat of combustion) are the primary indicators of the material's hazard to life and property. At the present time these fire hazard indicators: ignition temperature, burning rate, heat release rate, and heat of complete combustion are measured using procedures published by the American Society for Testing and Materials (ASTM) in at least three separate devices requiring at least 1 kilogram of material to complete all of the tests. Consequently, an instrument and method that measures ignition temperature, burning rate, heat release rate, and heat of combustion in a single, rapid, and quantitative test under fire-like conditions using a small amount (milligrams) of substance is of theoretical and practical importance to fire protection engineers and materials scientists.

“IGNITION TEMPERATURE” is the lowest temperature at which a material thermally decomposes to fuel gases. The fuel gases mix with air, burn, and liberate combustion heat with a luminous flame. Ignition temperature is currently measured in either a hot air furnace (ASTM D 1929, Standard Test Method for Determining Ignition Temperature of Plastics) or by using an electrically-heated (glowing) wire of known temperature (ASTM D 6194, Standard Test Method for Glow Wire Ignition of Materials). In either case, the ignition temperature of the sample is obtained by a tedious and time consuming bracketing procedure of raising or lowering the furnace/glow wire temperature until incipient ignition is observed. Moreover, the sample temperature at ignition is not measured directly. Instead, ignition temperature is inferred from the measured temperature of the furnace or glow wire which may be significantly (>50 degrees Celsius) different from the actual sample temperature. In the hot air furnace test (ASTM D 1929) samples weighing 3 grams are used for each test/iteration of the bracketing procedure. The repeatability (intralaboratory variation) of ignition temperatures measured by this method is ±11 degrees Celsius while the reproducibility (interlaboratory variation) is ±58 degrees Celsius. In the glow wire test (ASTM D 6194) between 1 gram and 50 grams are needed for each test in the bracketing procedure and the accuracy (correct value) of the result is no better than ±25 degrees Celsius.

“BURNING RATE” is the rate at which the material generates fuel (loses mass) in a fire. Burning rate is measured simultaneously with heat release rate in flaming combustion using fire calorimeters with sample weighing capability such as ASTM E 1354, Standard Test Method for Measuring Heat and Visible Smoke Release Rates for Materials and Products Using an Oxygen Consumption Calorimeter, and ASTM E 2058, Standard Test Method for Measurement of Synthetic Polymer Material Flammability Using a Fire Propagation Apparatus. Burning rate can be measured without measuring heat release rate in a separate device described in ASTM E 2102-04a, Standard Test Method for Measurement of Mass Loss and Ignitability for Screening Purposes Using a Conical Radiant Heater. The ASTM E 2102-04a gasification device measures burning (mass loss) rate without measuring heat release rate. Replicate samples on the order of 100 grams each are required for any of these burning rate tests.

“HEAT RELEASE RATE” is the rate at which heat is liberated by flaming combustion in a fire. Heat release rate is measured in fire calorimeters such as described in ASTM E 1354, Standard Test Method for Measuring Heat and Visible Smoke Release Rates for Materials and Products Using an Oxygen Consumption Calorimeter, and ASTM E 2058, Standard Test Method for Measurement of Synthetic Polymer Material Flammability Using a Fire Propagation Apparatus. Fire calorimeters measure the heat release rate with simultaneous measurement of the fuel generation (mass loss) rate of a substance. The repeatability (intralaboratory variation) of heat release rate measurements by fire calorimetry (ASTM E 1354 or ASTM E 2058) is ±15% while the reproducibility (interlaboratory variation) is ±25%. Replicate samples on the order of 100 grams each are required for these heat release rate tests.

“HEAT OF COMBUSTION” is the quantity of heat liberated by oxidation of fuel gases. Heat of combustion is measured in both flaming mode and nonflaming mode. The heat of combustion (Joules) is obtained by multiplying the heat release rate (Joules/second) by the sampling interval (seconds) at each point of time during the heat release rate test and summing the results. This procedure is called integration and it gives the area under the heat release rate versus time curve. In flaming mode, a fire calorimeter is used (see Heat Release Rate, above) but the heat of combustion of the fuel gases so measured is an effective value that is less than the total amount that is available because the combustion reactions in the flame are relatively inefficient at converting fuel gases to stable combustion products (water, carbon dioxide, and acid gases) because the fuel gases and air mix by diffusion. Typical flaming combustion efficiencies are in the range 50% to 95% of theoretical values. The repeatability of heats of flaming combustion determined by ASTM E 1354 or ASTM E 2058 is ±10% while the reproducibility is ±16%. Heat of combustion is also measured in nonflaming mode using an adiabatic oxygen bomb calorimeter, e.g., ASTM D 2015, Standard Test Method for Gross Calorific Value of Coal and Coke by the Adiabatic Bomb Calorimeter. In contrast to the fire calorimeter, the oxygen bomb calorimeter over-estimates the amount of heat available from the material in a fire because, under the conditions of the test (pure oxygen under high pressure), the entire organic part of the sample is consumed by combustion, including the carbonaceous char that is normally left behind in a fire and acts as a flame suppressant. Heats of complete combustion of fuel gases are also measured in nonflaming mode using microscale combustion calorimeters (Lyon and Walters, U.S. Pat. No. 5,981,290 and Lyon U.S. Pat. No. 6,464,391) that pyrolyze the sample and thermally oxidize (combust) the fuel gases in separate steps. Physical separation of the pyrolysis and combustion processes in Lyon & Walters and Lyon allowed samples to be tested under fire-like conditions. However, the Lyon & Walters device was later found to have poor mass transfer between the pyrolysis and combustion stages and the Lyon device had large signal noise associated with the mathematical procedure (deconvolution) used to correct for excessive mixing in the long (12 foot, coiled) combustion chamber that precluded an accurate determination of the heat release rate or ignition temperature of the sample.

Because flaming combustion requires large (kilogram) samples and the thermal history and combustion environment vary from test to test, the errors involved in fire calorimetry and ignition tests in flaming combustion are of the order of 20% (see Ignition Temperature, Heat Release Rate, and Heat of Combustion, above). Consequently, these are not the methods of choice for accurately and quickly measuring the fire properties of limited quantities of materials. Consequently, although the ignition temperature, the burning rate, the heat release rate, and the heat of combustion of the fuel gases of a combustible material can be separately determined using (at least) three devices and a large mass (kilogram) of sample, the process is expensive, time consuming and inefficient for materials research or quality control testing where small samples are all that is typically available

RELATIONSHIP BETWEEN FIRE QUANTITIES: The heat release rate (HRR) is the product of the mass loss rate (MLR) or burning rate and the heat of combustion (HOC):
HRR=MLR×HOC

In practice (i.e., in fire calorimeters) mass loss rate and heat release rate are measured continuously during the test by gravimetry and oxygen consumption, respectively. These quantities are used to calculate the instantaneous heat of combustion during the test
HOC=HRR/MLR

If the heat of combustion does not change significantly during the test, the mass loss rate at any time is
MLR=HRR/HOC

In other words, the mass loss rate of a sample heated to above its ignition temperature in an oxygen consumption calorimeter could be obtained simply by dividing the heat release rate HRR by the heat of combustion HOC at every point in time during the test. A non-contact mass loss rate measurement so described is only possible if there is no smearing or significant noise (uncertainty) in the oxygen consumption signal used to calculate the heat release rate in oxygen consumption calorimeters. FIG. 2 shows data for the mass loss rate/burning rate of a sample of PLEXIGLASS™ plastic heated in a thermogravimetric analyzer (TGA) from 200 to 500 degrees Celsius. Open circles are the measured (gravimetric) weight and the solid line is the instantaneous heat release rate divided by the total heat of combustion from the test, i.e., MLR=HRR/HOC. Good agreement is seen between the actual (measured) mass loss rate and the mass loss rate that is inferred from the combustion gases without directly contacting the sample.

A number of thermoanalytical methods and commercial instruments (thermogravimetric analyzer or TGA) are available that use controlled thermal decomposition of milligram-sized samples to measure burning rate under well-defined (laboratory) conditions. Simultaneous analysis of the evolved TGA gases permits calculation of the heat release and heat release rate using thermochemical calculations. Combustion of the evolved gases permits direct determination of the heat released by combustion, but heat release rate can only be measured if the oxygen consumed in burning the fuel gases is synchronized with their generation during the test. Of those known laboratory thermoanalytical methods that have been used to measure the heat of combustion of the sample gases under simulated fire conditions, all measure the total heat of combustion of the sample pyrolysis (fuel) gases. However, only the methods that measure or reproduce the mass loss rate of the sample can determine heat release rate of an individual material particle (specific heat release rate) as it occurs at a burning surface in a fire. The heat release rate in a fire during steady flaming combustion is equal to the specific mass loss rate (rate at which the solid particle decomposes into fuel which can enter the gas phase/flame) multiplied by the thickness of the heated surface layer (number of solid particles involved in the fuel generation process), the heat of combustion of the particles (heat released per particle by complete combustion), and the efficiency of the combustion process in the flame (fraction of solid particles which enter the gas phase and are completely combusted). Because the rate of mass loss at the burning surface is a relatively slow process in comparison to the gas phase combustion reactions in the flame, the heat release in a fire is simultaneous with the mass loss (fuel generation) rate of the sample. Moreover, the temperature at which flaming combustion begins is essentially the temperature at which the sample mass loss (fuel generation) rate reaches a particular (critical) value. Consequently, unless the evolved gas measurement is synchronized with the sample mass loss in a laboratory test, the ignition temperature and heat release rate as they occur in a fire cannot be measured. One approach to obtain the rate of heat released by the sample under fire conditions is to measure mass loss (fuel generation) rate and heat of combustion of the fuel gases separately and then multiply them together.

Lyon and Walters have invented and patented a microscale combustion calorimeter that measures flammability parameters of milligram samples of combustible materials. U.S. Pat. No. 5,981,290. In order to obtain results consistent with other techniques, the invention requires the simultaneous measurements of the mass loss rate of the sample, and the amount of oxygen consumed by combustion of the fuel gases given off by the sample. The mass loss rate is measured by using a thermogravimetric analyzer (TGA), while the amount of oxygen consumed is measured using a mass flow meter and oxygen analyzer downstream from the combustor. However, the oxygen consumption signal used to calculate heat release rate and heat release was distorted in the pyrolyzer by mixing and dilution of fuel gases with purge gases, and in the combustor by diffusion of combustion products. The combination of errors arising from the two separate mixing processes (i.e., mixing and dilution in the pyrolyzer and diffusion in the combustor) severely distorted the heat release history and precluded an accurate determination of heat release rate by this technique. Consequently, only the heat of combustion could be determined with any accuracy.

A later invention of Lyon solved a number of problems discovered in the earlier Lyon & Walters invention and is described in U.S. Pat. No. 6,464,391. This later invention reduced the volume of the pyrolysis chamber, which eliminated the mixing and dilution problem in the pyrolyzer by imposing “plug-like flow” on the stream of pyrolysis gases exiting the pyrolyzer and entering the combustion chamber. Reduction of the pyrolyzer volume significantly reduced the mixing and dilution of fuel gases by the purge gas and allowed for a mathematical deconvolution of the oxygen depletion history that would reproduce the original pyrolysis and mass-loss history thus giving the heat release rate of the sample. However, the mathematical deconvolution procedure introduced considerable noise (uncertainty) in the heat release rate history—both in time and in magnitude. Moreover, this heat release rate calorimeter was not easily adaptable to measurements of liquids, had no capability for directly measuring sample temperature, and the transition between the separate pyrolyzer and combustor introduced an abrupt temperature drop that delayed and distorted the continuous passage of the products of pyrolysis into the combustor. The greatest source of error, however, proved to be the measurement uncertainty associated with the mathematical deconvolution to correct for diffusional mixing in the long (12 foot) combustion tube which had an internal volume of 100 cm³. The long combustion tube allowed ample time (60 seconds, typically) for diffusion (spreading) of the combustion products (water, carbon dioxide and acid gases) prior to measurement of the oxygen depletion at the terminal end of the process. Because of this spreading and diffusion, even in the presence of plug-like flow mathematical deconvolution was needed to connect the oxygen depletion history to the mass-loss history. Further analysis of the time required for complete combustion of the pyrolysis gases was necessary to reduce the residence time in the combustion chamber. This analysis determined that a residence time on the order of 1 to 10 seconds, or so, was sufficient.

While the rate and amount of heat released during combustion of a material yields information related to flammability, the temperature at which ignition occurs also influences fire growth. Previous calorimeters, including the calorimeter described in U.S. Pat. No. 6,464,391, measure and control the temperature of the pyrolyzer, not the sample, and therefore cannot be used to determine the ignition temperature because thermal lag during heating causes unknown differences between the sample temperature and the measured pyrolyzer temperature. The sample temperature cannot be inferred from the time axis (seconds) and pryolyzer heating rate (degrees Celsius per second) because of the uncertainty in the time at maximum (peak) heat release rate introduced by the mathematical deconvolution procedure.

For the foregoing reasons, there is a need for a flammability tester that accurately and rapidly measures the rate, temperature, and amount of heat released by combustion of a small sample of material

### OBJECTS OF THE INVENTION

Accordingly, it is an object of the present invention to provide a device and method for quickly and accurately measuring flammability properties of milligram and centigram samples of combustible materials.

It is also an object of the present invention to provide a device and method for quickly and accurately measuring the heat release rates of milligram and larger samples of combustible materials without the need to simultaneously measure the mass loss rate of the sample and the heat of combustion of the fuel gases.

It is also an object of the present invention to provide a device and method for accurately measuring the heat release rates of milligram and larger samples of combustible materials without the need to mathematically correct (deconvolute) the oxygen consumption signal to account for diffusion in the combustion chamber.

It is also an object of the present invention to provide a device and method for accurately measuring the ignition temperature of milligram and larger samples of combustible materials without the need to simultaneously measure the mass loss rate of the sample and the heat of combustion of the fuel gases.

It is a further object of the present invention to provide a device and method to directly measure the ignition temperature of milligram and larger samples of combustible materials as the temperature at which the heat release rate reaches a prescribed value, which may be the maximum value during the test.

It is a further object of the present invention to provide a device and method for accurately measuring the fuel generation (ignition) temperature of combustible materials by measuring the heat release rate of milligram-sized samples

It is a further object of the present invention to provide a device and method for accurately measuring the fuel generation/mass loss/burning rate versus temperature of combustible materials by measuring the heat release rate of milligram-sized samples without the need to weigh the sample during the test.

It is a further object of the present invention to provide a device and method for quickly and accurately measuring the heat release rate, ignition temperature, and heat of combustion of milligram and larger samples of combustible materials in a single experiment.

It is a still further object of the present invention to provide a device and method for quickly and accurately measuring the heat release rate, ignition temperature, and heat of combustion of milligram and larger samples of combustible materials in a single experiment by directly relating the oxygen consumption rate to the fuel gas production (burning) rate of a pyrolyzing sample.

It is a still further object of the present invention to provide a device and method for accurately measuring the heat release rate, the ignition temperature, and the heat of combustion of milligram and larger samples of combustible materials in a single experiment using the temperature at which the fuel gas production (burning) rate of a pyrolyzing sample is a particular value, which may be the maximum value during the test.

It is a still further object of the present invention to provide a device and method for quickly and accurately measuring the heat release rate, the ignition temperature, and the heat of combustion of milligram and larger samples of combustible materials in a single, constant heating rate experiment, by directly relating the oxygen consumption history of the sample to its temperature history.

It is a still further object of the present invention to provide a device and method for quickly and accurately measuring the heat release rate, the ignition temperature, and the heat of combustion of milligram and larger samples of combustible materials in a single, constant heating rate experiment, by reducing the residence time of the fuel gases in the combustor to a minimum value.

It is a still further object of the present invention to provide a device and method for quickly and accurately measuring the heat release rate, the ignition temperature, and the heat of combustion of milligram and larger samples of combustible materials in a single, constant heating rate experiment, by reducing the residence time of the fuel gases in the pyrolyzer and combustor to a minimum value so as to directly relate the oxygen consumption history to the mass loss (burning) rate and heat release rate histories without the need for mathematical corrections to account for diffusion and mixing of the combustion gases.

It is a still further object of the present invention to provide a device and method for quickly and accurately measuring the heat release rate, the ignition temperature, and the heat of combustion of milligram and larger samples of combustible materials in a single, constant heating rate experiment in which the pyrolyzer and combustor are a single tube with separate heating zones in order to ensure continuous flow of the combustion gas stream, to obtain a minimum residence time to reduce the time available for diffusional mixing, and to directly relate the oxygen consumption history to the sample temperature, mass loss (burning) rate and heat release rate at all times during the test.

### SUMMARY

Briefly, the present invention is a flammability tester that measures flammability parameters, including ignition temperatures, burning rates, heat release rates, and heats of combustion of small samples (on the order of one to 100 milligrams) without the need to separately and simultaneously measure the mass loss rate of the sample and the heat of combustion of the fuel gases produced during the mass-loss process. This is accomplished by reducing the size of the pyrolysis chamber so that the fuel gases are carried along by an inert gas stream in essentially the same order as they are generated in the pyrolysis process with a minimum amount of dispersion within the gas stream and by substantially reducing the length of the path through the combustion chamber. Experimentation by the inventor concluded that a shorter time (on the order of 1 to 10 seconds, or so) for complete combustion of pyrolysis gases permitted a much shorter combustion path. The pyrolyzer can now be seamlessly connected to the combustor, constructed as a single straight tube, and the resulting tester assembled vertically to permit analysis of both solids and liquids. Seamless connection of the pyrolyzer and combustor also eliminates the abrupt temperature gradient between the two and permits the introduction of oxygen directly into the combustion chamber at the ambient temperature of the combustor. The quick passage of the gases through the tester eliminates the need to mathematically deconvolute the oxygen depletion history because intermingling and dispersion of the burning gases is substantially reduced and sequential flow is sustained throughout the tester. The oxygen consumption history remains synchronized with the mass loss history of the pyrolyzing sample. Direct measurement of the temperature of the pyrolyzing sample determines the precise temperature when the mass release rate is at its maximum.

In the present invention, the total path length of the fuel gases through the flammability tester, from pyrolyzer through the combustor to the analyzer is substantially shortened well below that of conventional calorimeters and flammability testers. The time needed for the gases to reside in the combustor is much shorter than previously thought, thus permitting the combustor to have a much smaller volume (about 10 cm³, typically) than that of combustion chambers normally used in conventional gas combustion calorimeters (about 100 to 400 cm³, typically). FIG. 3 shows the Reaction Time (time required for 99.5 percent of the fuel to be fully oxidized) for several hydrocarbon polymers and a gas (methane) as a function of the combustor temperature. At the combustor temperature usually employed in the invention, the most common fuel gases are almost completely oxidized well within 10 seconds. The small combustor volume, and consequent short combustor length, substantially diminishes the smearing of the combustion gases and residual oxygen in the inert gas stream and enhances the local confinement within successive elements of the sequential flow of the combustion products and unreacted oxygen. Real-time reading of the oxygen depletion history is more directly related to the liberation of the fuel gases and mass depletion rate of the disintegrating sample. Mathematical deconvolution of the oxygen consumption pulse shape to determine the heat release rate, as taught by Lyon in U.S. Pat. No. 6,464,391, is no longer necessary.

### BRIEF DESCRIPTION OF THE DRAWING

FIG. 1A is an idealized cross-sectional view of the present invention embodying an integral pyrolyzer-combustor tube.

FIG. 1B is an idealized cross-sectional view of the present invention embodying a separate pyrolyzer that may be a commercial thermogravimetric analyzer (TGA).

FIG. 2 is a graph of burning rate versus temperature of a sample of PLEXIGLASS™ plastic.

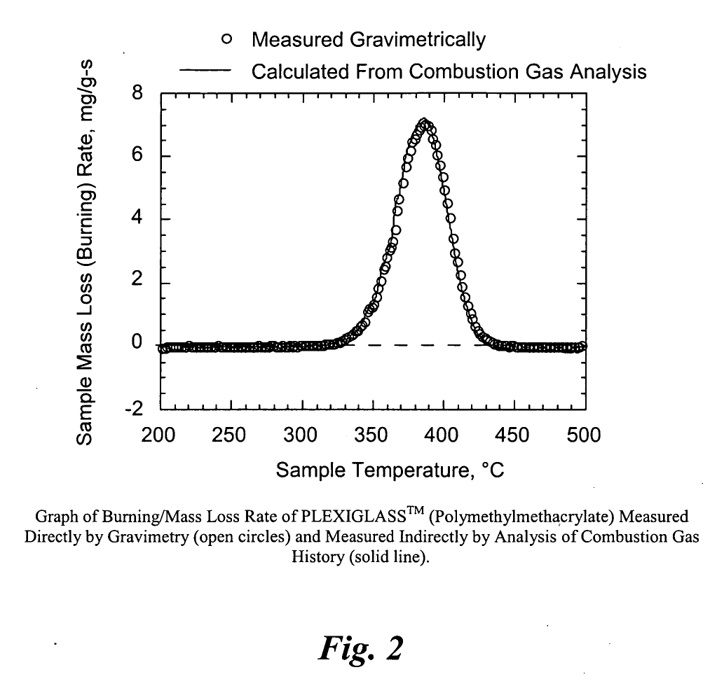

FIG. 3 is a graph of reaction time versus combustor temperature for complete oxidation of various hydrocarbon fuels.

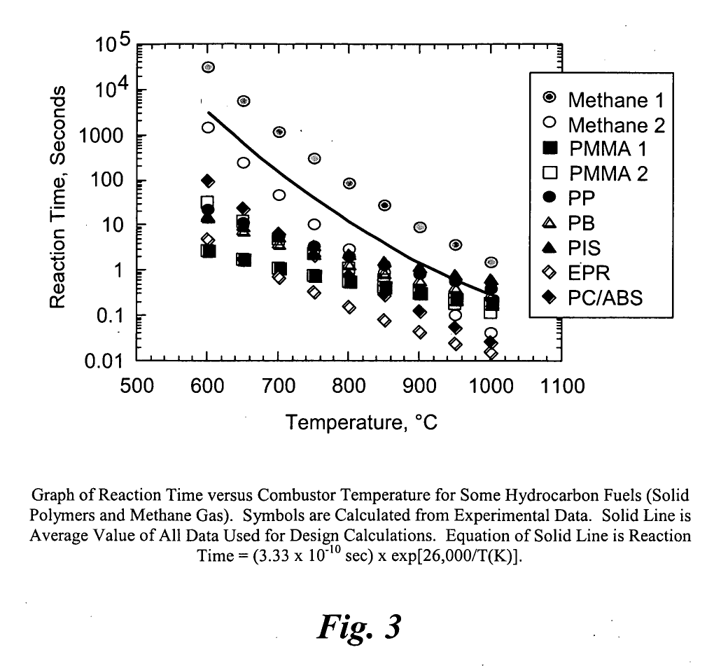

### DETAILED DESCRIPTION OF THE INVENTION

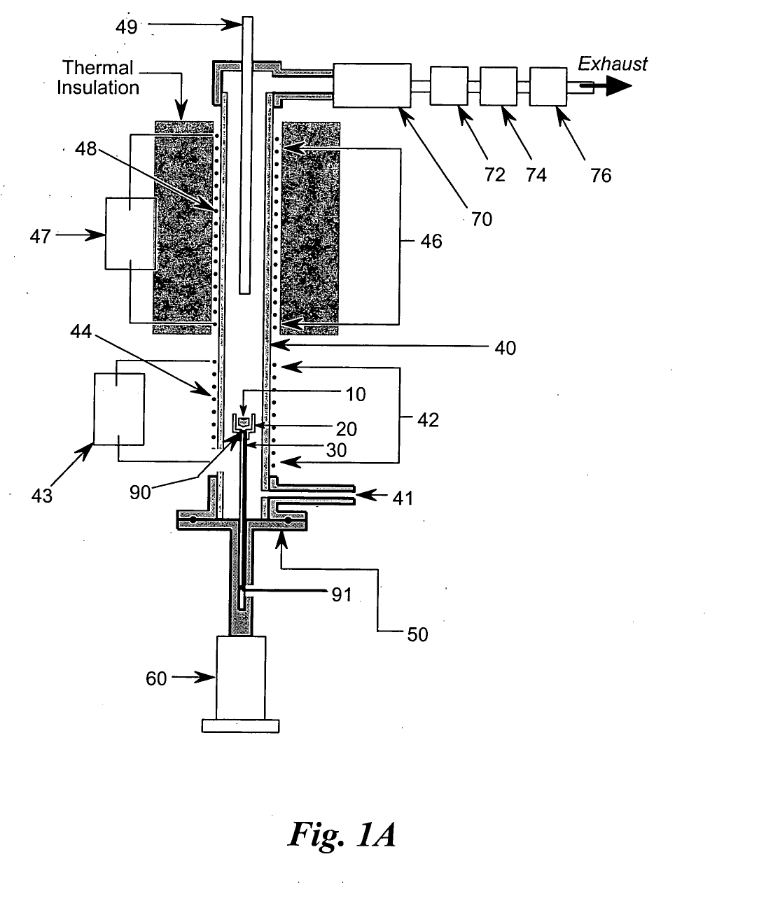

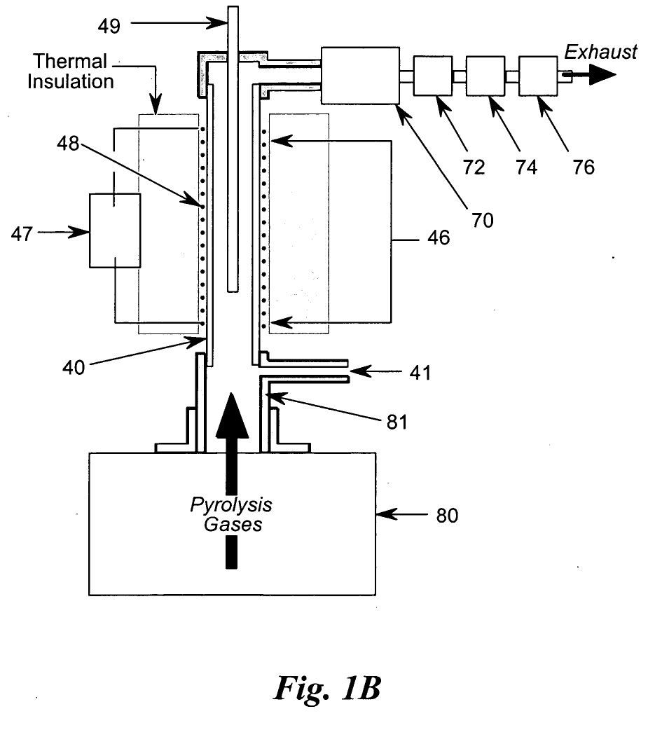

In the flammability tester of FIG. 1A, the test sample 10 is placed in sample cup 20 located at the top of sample mounting post 30 inserted into ceramic tube 40 using flange and sample mounting post assembly 50 attached to actuator 60. While the present embodiment uses a nonporous ceramic tube with an internal diameter of approximately one centimeter, other suitable high-temperature capable and corrosion resistant materials, such as Inconel™, Monel™, etc., and other convenient diameters would also suffice. The lower section of ceramic tube 40 constitutes the pyrolysis chamber, or pyrolyzer 42 of the tester, while the upper section of ceramic tube 40 constitutes the combustion chamber, or combustor 46 of the tester. In the present embodiment, the combustor 46 is approximately eight inches (20 cm) long. Sample actuator 60 positions sample 10 into ceramic tube 40 by sliding sample cup 20 on mounting post 30 upward into ceramic tube 40 until flange and sample mounting post assembly 50 forms a gas tight seal with the lower end of tube 40. Pyrolysis power supply 43 provides power to pyrolyzer heating coil 44, and similarly, combustor power supply 47 powers combustor heating coil 48. Pyrolyzer heating coil 44 and combustor heating coil 48 are separately wrapped around ceramic tube 40 to heat the ceramic tube 40. Pyrolyzer power supply 43 can vary the temperature of pyrolyzer 42 in a controlled manner, and at a predetermined, constant rate of temperature rise in the range of about 1 to 100 degrees Celsius per minute, and typically 60 degrees Celsius per minute. The combustor 46 is maintained at a relatively constant temperature during the test by combustion power supply 47. The temperature of the combustor 46 can be adjusted, but is ordinarily set in the range from about 600 to 1000 degrees Celsius. Combustor 46 can be set to operate at lower temperatures, but such operation is typically done in the presence of catalysts to ensure complete combustion of the fuel gases. In testing flammability parameters of plastics, halogens, phosphorus, and other contaminants easily poison the catalyst and degrade the accuracy of such calorimeters. By choosing to operate at temperatures above approximately 800 degrees Celsius, catalysts are not necessary to effect rapid combustion, and catalyst poisoning is avoided. Pyrolyzer 42 provides radiant heat to sample 10 to induce thermal decomposition (pyrolysis) of sample 10 thus liberating products of pyrolysis (fuel gases). An inert gas stream (e.g., nitrogen at about 80 cubic centimeters per minute) is introduced into pyrolyzer 42 through purge gas inlet 41 located below sample cup 20 to carry fuel gases from sample 10 upward through combustor 46. This desired flow through the tester will be designated “sequential flow” because the gases that emerge from the pyrolyzer 42 enter the combustor 46 in the order in which they were produced by the thermally decomposing sample 10 and travel in sequence with minimum forward or backward diffusion through the combustor 46 because of the short reaction time and in the absence of any extraneous cavities or spaces that would delay the passage of fuel gases. Because the reaction time needed for complete combustion can range from about 1 to 10 seconds, or so, depending on the combustor temperature which is usually between 800 and 1000 degrees Celsius, the volume of combustor 46 can be small, and the length of the tube 40 constituting combustor 46 can be short, on the order of eight inches (20 centimeters), where the internal diameter of tube 40 is approximately 1 centimeter. The fuel gases are essentially synchronized with the mass loss rate of the sample 10, according to the order and time when they were liberated by pyrolysis.

Oxygen is metered into combustor 46 through oxygen inlet tube 49 at about 20 cubic centimeters per minute to mix with and fully oxidize the fuel gases as they flow through the combustor 46. In this embodiment, oxygen is introduced into the fuel gases within the combustor 46, rather than prior to entering the combustion process as in previous calorimeters of this type. One advantage of this approach is to have the fuel gases and oxygen mix at the same high temperature within the combustor 46 so that mixing is instantaneous and complete oxidation of the fuel gases occurs quickly in combustor 46, yielding unreacted oxygen, stable carbon and hydrogen oxides (i.e. CO₂ and H₂O), and possible acid gases (e.g. HCl, HF, H₂SO₄, etc.), all of which are carried by the inert gas stream upward through a series of gas conditioning elements 70 that remove specific combustion products from the emerging gas stream. The series of gas conditioning elements 70 can include, preferably a thermoelectric cold trap, or a Drierite™ absorbent tube to remove water, and an Ascarite™ adsorbent tube to remove the CO₂ and acid gases. The gas stream and unreacted oxygen continue in sequential flow to oxygen analyzer 72, then to optional carbon dioxide sensor 74, and then to flow meter 76 before being exhausted from the tester. Allowing the CO₂ to remain in the effluent gas stream permits the terminal flow rate to remain relatively constant and equal to the initial flow rate of combustion gas stream passing through the pyrolyzer 42 and combustor 46 for typical hydrocarbon fuels.

FIG. 1B shows another embodiment of the flammability tester in which the pyrolyzer is a separate device 80 that is adapted for such use. An example of such a separate pyrolyzer is a commercial thermogravimetric analyzer 80 that is capable of weighing the sample during the heating program of the test. The separate pyrolyzer 80 is necessarily attached to combustor 46 with a small-volume coupling 81 that is heated to a temperature between the sample temperature and the combustor temperature during the test to prevent mixing and condensation of fuel gases prior to their entry into the combustor 46. Constructed in this way, the resulting flammability tester takes full advantage of the rapid, complete combustion of the fuel gases within the small volume combustor 46, while allowing the use of a pre-existing thermogravimetric analyzer 80.

One significant additional benefit to the small total volume of the tester is that the oxygen analyzer can be of the type typically employed in automobile emission testing systems, rather than the expensive high sensitivity analyzers usually needed for over-ventilated fire calorimetry measurements in air where the change in oxygen concentration is typically less than 1 percent of the amount in the air during the test. This substitution is possible because the heating (mass loss) rate of the sample, the purge gas flow, and the oxygen flow can be separately controlled to maximize the amount of oxygen consumed in the combustor 46 so that it is typically in the range of 50 to 80% of the amount that is introduced through oxygen inlet tube 49. The ability to independently control the sample heating rate and gas flow rates favors optimal ventilation (oxygen consumption) and complete combustion of the fuel gases. Further significant reduction of the noise in the oxygen consumption history is achieved by reducing the combustor volume because sequential flow of the fuel gases is maintained throughout the combustion process. Where expensive oxygen analyzers are needed to detect minute variations in O₂ content, in the present invention, the large fluctuations in O₂ content as a percentage of oxygen metered in, are easily measured by the low cost oxygen sensors used in automobile emission testing systems. For example, oxygen analyzer 72, utilized in the present embodiment in FIG. 1A or 1B, is Oxygen Sensor Model R17A, available from Teledyne Analytical Instruments, City of Industry, Calif., 91748. Low cost oxygen sensors operating on a different principle are also suitable for use in this invention. Such alternate oxygen sensors include the Figaro KE-25 and KE-12. Compact electrochemical sensors that operate at room temperature and that are significantly more expensive than the R17A are available from Advanced Micro Instruments (Model 65), from MBE (Parox 1000), and from Servomex (Model Pm1111E). Such large fluctuations in the oxygen content easily emerge from the noise inherent in such meters, and identifying the exact time of the oxygen depletion peak in the sequential flow is much more precise. This peak time, offset by the transit time of the gases through the tester, directly yields the time at which the maximum heat release of the pyrolyzing sample occurred, and identically the time and temperature at which ignition occurred.

In some applications, the carbon dioxide present in the effluent gases emerging from combustor 46 is not removed, but allowed to continue to further analysis using carbon dioxide (CO₂) sensor 74. Measurement of the CO₂ content of the effluent, instead of, or in addition to, measurement of the O₂ content can yield useful flammability parameters as well, in particular the carbon content of the fuel. Carbon dioxide sensors operating at room temperature with comparable sensitivity and accuracy to the R17A oxygen sensor are made by Texas Instruments (Model 9GS) and Valtronics (Model 2208-20 CO2 monitor), but are more expensive. Generally, measurements of flammability parameters derived from CO₂ sensors are less accurate than those obtained through the O₂ consumption calorimetry used in the present invention.

While the detailed description above shows how the invention may be used to measure the heat release rate of a small sample of combustible material, the ignition temperature may be read directly by placing temperature sensor 90 in thermal contact with sample cup 20, which is placed in thermal contact with test sample 10. Temperature sensor 90 measures the temperature of test sample 10 during the test and may provide a signal through temperature sensor leads 91 to power supply 43 to control the sample heating rate. The temperature at which the heat release rate reaches its maximum value occurs at or near the ignition temperature. Since the time of the oxygen depletion peak is directly connected to the time at which the maximum heat release rate of the sample occurs, a detailed knowledge of the temperature history of the pyrolyzing sample yields the combustion temperature indirectly from the sample heating rate or directly through temperature sensor 90

Finally, the heat of complete combustion is computed by taking the entire area under the curve of the oxygen depletion rate over the time of combustion and multiplying this value by a constant number relating the heat evolved to the oxygen consumed by combustion, the number being 13.1 kilojoules of heat liberated for each gram of oxygen consumed, regardless of the type of fuel being tested. This is the principle of oxygen consumption calorimetry on which the present and past embodiments of microscale combustion calorimeters and fire calorimeters operate.

All of these quantities: heat release rate, burning rate, heat of complete combustion, and ignition temperature, can be measured using the present invention in a single experimental step. Other flammability parameters of interest can be derived from these quantities.

I claim:

1. A flammability tester providing a quantitative measure of flammability parameters of a sample, said tester comprising:
a. A tube having a lower pyrolyzing region and an upper combustion region, wherein said pyrolyzing region thermally decomposes said sample under anaerobic conditions to produce fuel gases;
b. a stream of inert gas within said tube for transporting said fuel gases from said pyrolyzing region to said combustion region in substantial sequential flow;
c. means for inserting a measured amount of oxygen into said combustion region into said inert gas stream and said fuel gases, said measured amount of oxygen at least sufficient to completely combust said fuel gases within said combustion region;
d. means for collecting gases emerging from said combustion region;
e. means for measuring the amount of oxygen present in said gases emerging from said combustion region; and,
f. computational means for computing flammability parameters of said sample from said measured amount of oxygen inserted into said fuel gases and inert gas stream and the said amount of oxygen present in said gases emerging from said combustion region.

2. The flammability tester of claim 1 further comprising:
a. a sample holder in thermal contact with said sample;
b. a thermometer in thermal contact with said sample holder, and,
c. means for providing the temperature measured by said thermometer to said computational means for computing flammability parameters of said sample from said temperature, said measured amount of oxygen inserted into said fuel gases and inert gas stream, and said amount of oxygen present in said gases emerging from said combustion region.

3. The flammability tester of claim 1 wherein said tube is essentially of uniform cross section, essentially straight, and essentially vertical.

4. The flammability tester of claim 2 wherein said tube is essentially of uniform cross section, essentially straight, and essentially vertical.

5. The flammability tester of claim 1 wherein said combustion region is at a temperature between about 600 degrees Celsius and about 1000 degrees Celsius and has a volume corresponding to a reaction time for said fuel gases at or less than 10 seconds.

6. The flammability tester of claim 2 wherein said combustion region is at a temperature between about 600 degrees Celsius and about 1000 degrees Celsius and has a volume corresponding to a reaction time for said fuel gases at or less than 10 seconds.

7. The flammability tester of claim 3 wherein said combustion region is at a temperature between about 600 degrees Celsius and about 1000 degrees Celsius and has a volume corresponding to a reaction time for said fuel gases at or less than 10 seconds.

8. The flammability tester of claim 4 wherein said combustion region is at a temperature between about 600 degrees Celsius and about 1000 degrees Celsius and has a volume corresponding to a reaction time for said fuel gases at or less than 10 seconds.

9. A flammability tester providing a quantitative measure of flammability parameters of a sample, said tester comprising:
a. A tube having a lower pyrolyzing region and an upper combustion region, wherein said pyrolyzing region thermally decomposes said sample under anaerobic conditions to produce fuel gases;
b. a stream of inert gas within said tube for transporting said fuel gases from said pyrolyzing region to said combustion region in substantial sequential flow;
c. means for inserting a measured amount of oxygen into said combustion region into said inert gas stream and said fuel gases, said measured amount of oxygen at least sufficient to completely combust said fuel gases within said combustion region;
d. means for collecting gases emerging from said combustion region;
e. means for measuring the amount of carbon dioxide present in said gases emerging from said combustion region; and,
f. computational means for computing flammability parameters of said sample from said measured amount of oxygen inserted into said fuel gases and inert gas stream and the said amount of carbon dioxide present in said gases emerging from said combustion region.

10. The flammability tester of claim 9 further comprising:
a. a sample holder in thermal contact with said sample;
b. a thermometer in thermal contact with said sample holder, and,
c. means for providing the temperature measured by said thermometer to said computational means for computing flammability parameters of said sample from said temperature, said measured amount of oxygen inserted into said fuel gases and inert gas stream, and said amount of carbon dioxide present in said gases emerging from said combustion region.

11. The flammability tester of claim 9 wherein said tube is essentially of uniform cross section, essentially straight, and essentially vertical.

12. The flammability tester of claim 10 wherein said tube is essentially of uniform cross section, essentially straight, and essentially vertical.

13. The flammability tester of claim 9 wherein said combustion region is at a temperature between about 600 degrees Celsius and about 1000 degrees Celsius and has a volume corresponding to a reaction time for said fuel gases at or less than 10 seconds.

14. The flammability tester of claim 10 wherein said combustion region is at a temperature between about 600 degrees Celsius and about 1000 degrees Celsius and has a volume corresponding to a reaction time for said fuel gases at or less than 10 seconds.

15. The flammability tester of claim 11 wherein said combustion region is at a temperature between about 600 degrees Celsius and about 1000 degrees Celsius and has a volume corresponding to a reaction time for said fuel gases at or less than 10 seconds.

16. The flammability tester of claim 12 wherein said combustion region is at a temperature between about 600 degrees Celsius and about 1000 degrees Celsius and has a volume corresponding to a reaction time for said fuel gases at or less than 10 seconds.

17. A combustor for achieving practically complete combustion of fuel gases contained in a stream of inert gas emerging from a source wherein said fuel gases were the products of a sample undergoing pyrolysis, said combustor comprising
a. a tube maintained at a temperature between about 600 degrees Celsius and about 1000 degrees Celsius, and
b. means for inserting a measured amount of oxygen into said tube, said measured amount of oxygen at least sufficient to achieve substantially complete combustion of fuel gases within said tube;
c. said tube further having a volume corresponding to a reaction time for complete combustion of said fuel gases at or less than 10 seconds.

18. The combustor of claim 17 wherein said tube is essentially straight and of essentially uniform cross section.

19. The combustor of claim 17 wherein said tube is essentially straight, essentially vertical, and of essentially uniform cross section.
